(19) United States
(12) Patent Application Publication
(10) Pub. No.: US 2012/0135315 A1
(43) Pub. Date: May 31, 2012

(54) NON-AQUEOUS ELECTROLYTE SECONDARY BATTERY

(75) Inventors: Fumiharu Niina, Kobe-shi (JP); Akihiro Suzuki, Kobe-shi (JP); Toshikazu Yoshida, Kasai-shi (JP); Shingo Tode, Kasai-shi (JP); Yoshinori Kida, Kobe-shi (JP); Hiroyuki Fujimoto, Kobe shi (JP)

(73) Assignee: SANYO Electric Co., Ltd., Moriguchi-shi, Osaka (JP)

(21) Appl. No.: 13/389,218

(22) PCT Filed: Aug. 6, 2010
(86) PCT No.: PCT/JP2010/063381

§ 371 Date: Feb. 6, 2012

(30) Foreign Application Priority Data
Aug. 7, 2009 (JP) 2009-184021

(51) Int. Cl. H01M 4/131; H01M 10/0564

(52) U.S. Cl. 429/332; 429/223

(57) ABSTRACT

A non-aqueous electrolyte secondary battery is provided that uses as a positive electrode active material a low-cost lithium-containing transition metal composite oxide containing Ni and Mn as its main components, to improve the output power characteristics so that it can be used suitably for an electric power source for, for example, hybrid electric vehicles. A non-aqueous electrolyte secondary battery has a positive electrode (11) containing a positive electrode active material, a negative electrode (12) containing a negative electrode active material, and a non-aqueous electrolyte solution (14) in which a solute is dissolved in a non-aqueous solvent. In the positive electrode active material, Nb₂O₅ in which the amount of niobium is 0.5 mol % with respect to the total amount of the transition metals and TiO₂ in which the amount of titanium is 0.5 mol % with respect to the total amount of the transition metals are disposed on a surface of Li_{1.06}Ni_{10.56}Mn_{10.38}O₂.

### TECHNICAL FIELD

The present invention relates to a non-aqueous electrolyte secondary battery comprising a positive electrode containing a positive electrode active material, a negative electrode containing a negative electrode active material, and a non-aqueous electrolyte solution in which a solute is dissolved in a non-aqueous solvent. More particularly, the invention relates to a non-aqueous electrolyte secondary battery employing, as the to positive electrode active material, a layered lithium-containing transition metal composite oxide containing Ni and Mn as its main components.

### BACKGROUND ART

In recent years, significant size and weight reductions have been achieved in mobile electronic devices such as mobile telephones, notebook computers, and PDAs. In addition, power consumption of such devices has been increasing as the number of functions of the devices has increased. As a consequence, a demand has been increasing for lighter weight and higher capacity non-aqueous electrolyte secondary batteries used as power sources for such devices. Furthermore, in order to resolve the environmental issues arising from vehicle emissions, development of hybrid electric vehicles, which use electric motors in conjunction with automobile gasoline engines, has been in progress in recent years.

Commonly, nickel-metal hydride storage batteries have been widely used as power sources for such electric vehicles, but the use of non-aqueous electrolyte secondary batteries has been studied as power sources that achieve higher capacity and higher power.

In the non-aqueous electrolyte secondary batteries, the positive electrode commonly comprises a positive electrode active material that employs a lithium-containing transition metal composite oxide, such as lithium cobalt oxide (LiCoO₂), which contains cobalt as a main component. However, there have been some problems with this type of non-aqueous electrolyte secondary battery. For example, the positive electrode active material contains scarce natural resources such as cobalt, so the cost tends to be high and the stable supply may be difficult. In particular, in applications such as the electric power sources for hybrid electric vehicles, a large number of the non-aqueous electrolyte secondary batteries are used. This necessitates a very large amount of cobalt, which increases the cost of the electric power source.

For these reasons, a positive electrode active material that employs nickel or manganese as the main material in place of cobalt has been studied to obtain a positive electrode that is less costly and can be supplied more stably. For example, layered lithium nickel oxide (LiNiO₂) is expected to be a material that achieves a high discharge capacity; however, it has the disadvantages of high overvoltage and poor safety because of its poor thermal stability. On the other hand, spinel-type lithium manganese oxide (LiMn₂O₄) has the advantage of abundance in natural resources and thus being less costly; however, it has the disadvantages that the energy density is low and the manganese dissolves in the non-aqueous electrolyte solution under a high-temperature environment.

For these reasons, layered lithium-containing transition metal composite oxide in which the main components of the transition metals are composed of two elements, nickel and manganese, has attracted attention from the viewpoints of being low cost and having good thermal stability. For example, various proposals have been made as described in the following (1) through (4).

(1) A lithium-containing composite oxide usable as a positive electrode active material that has substantially the same level of energy density as that of lithium cobalt oxide, that does not show poor safety unlike lithium nickel oxide or does not cause to manganese to dissolve in the non-aqueous electrolyte solution under a high-temperature environment unlike lithium manganese oxide. The lithium-containing composite oxide has a layered structure and contains nickel and manganese, and it has a rhombohedral structure wherein the difference of the atomic ratios of the nickel and the manganese is less than 10 atomic % (see Patent Document 1 below).

(2) A single phase cathode material in which portions of nickel and manganese in a layered lithium-containing transition metal composite oxide containing at least nickel and manganese are substituted by cobalt (see Patent Document 2 below).

(3) A positive electrode active material obtained by allowing niobium oxide or titanium oxide to exist on the surface of a lithium-nickel composite oxide and baking the lithium-nickel composite oxide (see Patent Document 3 below).

(4) A positive electrode active material in which a group 4A element and a group 5A element are added to a lithium-containing transition metal composite oxide containing nickel and manganese (see Patent Document 4 below).

### CITATION LIST

### Patent Literature

[Patent Document 1] Japanese Published Unexamined Patent Application No. 2007-012629
[Patent Document 2] Japanese Patent No. 3571671
[Patent Document 3] Japanese Patent No. 3835412
[Patent Document 4] Japanese Published Unexamined Patent Application No. 2007-273448

### SUMMARY OF INVENTION

### Technical Problem

However, the positive electrode active materials shown in the above (1) through (4) have the following problems.

### Problem with the Positive Electrode Active Material Shown in (1)

A problem with the positive electrode active material shown in (1) is as follows. It shows a high-rate charge-discharge capability considerably poorer than lithium cobalt oxide, so it is difficult to use for the electric power sources for, for example, electric vehicles.

### Problem with the Positive Electrode Active Material Shown in (2)

Problems with the positive electrode active material shown in (2) are as follows. When the amount of the cobalt that substitutes portions of the nickel and the manganese is large, the problem of high cost arises as described above. On the other hand, when the amount of the cobalt that substitutes portions of the nickel and the manganese is small, the problem of considerably poor high-rate charge-discharge capability arises.

### Problem with the Positive Electrode Active Material Shown in (3)

A problem with using the positive electrode active material as shown in (3), which is obtained by allowing niobium oxide or titanium oxide to exist on the surface of a lithium-nickel composite oxide and baking the lithium-nickel composite oxide, is that the high-rate discharge capability and the low-temperature discharge capability are rather to lowered, although the thermal stability of the positive electrode is improved.

### Problem with the Positive Electrode Active Material Shown in (4)

A problem with the positive electrode active material shown in (4) is that although it has been described that the I-V resistance is reduced, the battery performance such as high-rate charge-discharge capability cannot be necessarily improved because the amounts of the elements to be added are not discussed.

In view of the foregoing problems, it is an object of the present invention to, when using a layered lithium-containing transition metal composite oxide containing Ni and Mn as its main components as a positive electrode active material for a non-aqueous electrolyte secondary battery, to improve the positive electrode active material and thereby enhance the output power characteristics under various temperature conditions so that the battery can be suitably used as, for example, the electric power source of hybrid electric vehicles or the like.

### Solution to Problem

In order to accomplish the foregoing objects, the present invention provides a non-aqueous electrolyte secondary battery comprising: a positive electrode containing a positive electrode active material; a negative electrode containing a negative electrode active material; and a non-aqueous electrolyte solution containing a solute dissolved in a non-aqueous solvent, the non-aqueous electrolyte secondary battery being characterized in that: the positive electrode active material comprises a layered lithium-containing transition metal composite oxide containing Ni and Mn as its main components, and a niobium-containing substance and a titanium-containing substance existing on a surface of the lithium-containing transition metal composite oxide; the total amount of niobium in the niobium-containing substance and titanium in the titanium-containing substance is from 0.15 mol % to 1.5 mol % with respect to the total amount of transition metals in the lithium-containing transition metal composite oxide; and the number of moles of the niobium in the niobium-containing substance is equal to or greater than the number of moles of the titanium in the titanium-containing substance.

When using the positive electrode active material in which both the niobium-containing substance and the titanium-containing substance exist on the surface of the lithium-containing transition metal composite oxide, the output power characteristics can be improved under various temperature conditions, and therefore, the battery can be used suitably as the electric power source for, for example, hybrid electric vehicles. Although the details are not clear, the mechanism of improving the output power characteristics is believed to be as follows. The valency of the transition metals, such as nickel, in the lithium-containing transition metal composite oxide is changed because of the niobium and the titanium existing on the surface of the lithium-containing transition metal composite oxide. Thereby, the interface between the positive electrode and the non-aqueous electrolyte solution is modified, and the charge transfer reaction is promoted.

However, if the amounts of the niobium-containing substance and the titanium-containing substance existing on the surface of the lithium-containing transition metal composite oxide are small, the above-described advantageous effect cannot be obtained sufficiently. On the other hand, if the amounts of the niobium-containing substance and the titanium-containing substance are too large, the charge-discharge characteristics of the battery deteriorates because the niobium-containing substance and the titanium-containing substance, which are not conductive, widely cover the surface of the lithium-containing transition metal composite oxide widely (i.e., the covered portion becomes too large). For this reason, it is necessary that the total amount of the niobium in the niobium-containing substance and the titanium in the titanium-containing substance be from 0.15 mol % to 1.5 mol %, preferably from 0.15 mol % to 1.0 mol %, with respect to the total amount of the transition metals in the lithium-containing transition metal composite oxide. Taking cost advantages into consideration, it is preferable that the above-described advantageous effect can be obtained with the niobium-containing substance and the titanium-containing substance in as small amounts as possible.

In addition, if the amount of (i.e., the number of moles of) the titanium in the titanium-containing substance is larger than the amount of (i.e., the number of moles of) the niobium in the niobium-containing substance, the advantageous effects as described above cannot be obtained. It is believed that in the positive electrode active material, niobium exists in pentavalent state and titanium exists in tetravalent state. When the titanium amount is larger than the niobium amount, the effect of the niobium existing in pentavalent state on the transition metals such as nickel becomes insufficient. For this reason, it is necessary that the number of moles of the niobium in the niobium-containing substance be equal to or greater than the number of moles of the titanium in the titanium-containing substance.

It should be noted that the phrase “ . . . containing Ni and Mn as its main components” means that the total amount of Ni and Mn exceeds 50 mole % with respect to the total amount of the transition metals.

It is desirable that the lithium-containing transition metal composite oxide be represented by the general formula Li₁₊ₓNiₐMn_{b}Co_{c}O_{2+d}, where x, a, b, c, and d satisfy the following expressions: x+a+b+c=1, 0<x≦0.1, 0≦c/(a+b)<0.40, 0.7≦a/b≦3.0, and −0.1≦d≦0.1. It is more desirable that 0≦c/(a+b)<0.35 and 0.7≦a/b≦2.0. It is still more desirable that 0≦c/(a+b)<0.15 and 0.7≦a/b≦1.5.

In the lithium-containing transition metal composite oxide represented by the above general formula, the composition ratio c of cobalt, the composition ratio a of nickel, and the composition ratio b of manganese should satisfy the condition 0≦c/(a+b)<0.40. The purpose is to lower the proportion of cobalt and thereby reduce the material cost of the positive electrode active material. Taking this into consideration, it is preferable that 0≦c/(a+b)<0.35, and it is more preferable that 0≦c/(a+b)<0.15.

In the foregoing general formula, the composition ratio a of nickel and the composition ratio b of manganese should satisfy the condition 0.7≦a/b≦3.0. The reason is as follows. When the value a/b exceeds 3 and accordingly the proportion of nickel is high, the thermal stability of the lithium-containing transition metal composite oxide becomes considerably poor. Consequently, the temperature at which the heat generation reaches the peak is lowered, and the safety is degraded. On the other hand, when the value a/b is less than 0.7, the proportion of manganese is large. Consequently, an impurity phase is formed and the capacity is lowered. Taking this into consideration, it is preferable that 0.7≦a/b≦2.0, and it is more preferable that 0.7≦a/b≦1.5.

In the foregoing general formula of the lithium-containing transition metal composite oxide, the value x in the composition ratio (1+x) of lithium should satisfy the condition 0<x≦0.1. The reason is as follows. When 0<x, the output power characteristics improve. However, when x>0.1, the amount of the alkali that remains on the surface of the lithium-containing transition metal composite oxide is large, causing gelation of the slurry used in the process of fabricating the battery, and in addition, the amount of the transition metals involved in the oxidation-reduction reaction is small, resulting in a low capacity. Taking this into consideration, it is more preferable to use a lithium-containing transition metal composite oxide that satisfies the condition 0.05≦x≦0.1.

Moreover, in the above-described lithium-containing transition metal composite oxide, the value d in the composition ratio (2+d) of oxygen should satisfy the condition −0.1≦d≦0.1. The reason is to prevent an oxygen shortage state or an oxygen excess state of the above-described lithium-containing transition metal composite oxide and to thereby prevent the crystal structure thereof from being impaired.

It is desirable that the niobium-containing substance and the titanium-containing substance be sintered on the surface of the lithium-containing transition metal composite oxide.

The reason is that such a structure enables the niobium-containing substance and the titanium-containing substance to be firmly fixed to the surface of the lithium-containing transition metal composite oxide. An example of the method of sintering the niobium-containing substance and so forth onto the surface of the lithium-containing transition metal composite oxide is as follows. The lithium-containing transition metal composite oxide is mixed with predetermined amounts of the niobium-containing substance and the titanium-containing substance using such a technique as mechanofusion to cause the niobium-containing substance and the titanium-containing substance to adhere to the surface of the lithium-containing transition metal composite oxide. Thereafter, the resultant material is sintered at a temperature below the decomposition temperature of the lithium-containing transition metal composite oxide.

However, the method for allowing to the niobium-containing substance and the like to exist on the surface of the lithium-containing transition metal composite oxide is not limited to the just-described sintering method.

In addition, examples of the niobium-containing substance include Nb₂O₅ and LiNbO₃, and examples of the titanium-containing substance include Li₂TiO₃, Li₄Ti₅O₁₂, and TiO₂.

It should be noted that the aforementioned Patent Document 4 uses tetravalent zirconium (which corresponds to the tetravalent titanium in the present invention). However, it is difficult to industrially obtain a zirconium-containing substance with a small particle size. In contrast, the titanium-containing substance, which is used in the present invention, can be easily manufactured industrially at a small particle size. Thus, the use of the titanium-containing substance, as in the present invention, also has the advantage that it can be easily dispersed over the surface of the lithium-containing transition metal composite oxide.

It is desirable that the positive electrode active material have primary particles to having a volume average particle size of from 0.5 μm to 2 μm, and secondary particles having a volume average particle size of from 4 μm to 15 μm.

The reason is as follows. If the particle size of the positive electrode active material is too large, the conductivity of the positive electrode active material itself will be poor and consequently the discharge performance will be poor. On the other hand, if the particle size of the positive electrode active material is too small, the specific surface area of the positive electrode active material will be accordingly large and the reactivity with the non-aqueous electrolyte solution will be high, resulting in poor storage performance, for example.

It is desirable that the non-aqueous solvent of the non-aqueous electrolyte solution comprise a mixed solvent containing a cyclic carbonate and a chain carbonate in a volume ratio of from 2:8 to 5:5.

### Other Embodiments

(1) The lithium-containing transition metal composite oxide may contain at least one element selected from the group consisting of boron (B), fluorine (F), magnesium (Mg), aluminum (Al), chromium (Cr), vanadium (V), iron (Fe), copper (Cr), zinc (Zn), molybdenum (Mo), zirconium (Zr), tin (Sn), tungsten (W), sodium (Na), and potassium (K).

The positive electrode active material used for the non-aqueous electrolyte secondary battery of the present invention may not necessarily be composed of the above-described positive electrode active material alone, and it is possible that the above-described positive electrode active material may be used in combination with other to positive electrode active materials. The other positive electrode active materials are not particularly limited as long as they are compounds that can reversibly intercalate and deintercalate lithium. Examples include ones having a layered structure, a spinel-type structure, or an olivine-type structure, which can intercalate and deintercalate lithium while the stable crystal structure is kept.

(2) The negative electrode active material used for the non-aqueous electrolyte secondary battery of the present invention is not particularly limited as long as it can reversibly intercalate and deintercalate lithium. Examples include carbon materials, metal or alloy materials that can be alloyed with lithium, and metal oxides. From the viewpoint of cost of the material, it is preferable to use a carbon material for the negative electrode active material. Examples include natural graphite, artificial graphite, mesophase pitch-based carbon fiber (MCF), mesocarbon microbead (MCMB), coke, hard carbon, fullerene, and carbon nanotube. From the viewpoint of improving the high-rate charge-discharge capability, it is particularly preferable to use a carbon material in which a graphite material is covered with a low crystallinity carbon.

(3) The non-aqueous solvent used for the non-aqueous electrolyte solution in the non-aqueous electrolyte secondary battery of the present invention may be any known non-aqueous solvent that has been used commonly. Examples include cyclic carbonates such as ethylene carbonate, propylene carbonate, butylene carbonate and vinylene carbonate, and chain carbonates such as dimethyl carbonate, methyl ethyl carbonate, and diethyl carbonate. In particular, it is preferable to use a mixed solvent of a cyclic carbonate and a chain carbonate as it is a non-aqueous solvent having a low viscosity, a low melting point, and high lithium ion conductivity. In this mixed solvent, it is to preferable that the volume ratio of cyclic carbonate and chain carbonate be within the range of from 2:8 to 5:5, as described above.

It is also possible to use an ionic liquid as the solvent for the non-aqueous electrolyte solution. When this is the case, the cationic species and the anionic species are not particularly limited; however, from the viewpoints of obtaining low viscosity, electrochemical stability, and hydrophobicity, it is preferable to use a combination in which the cation is pyridinium cation, imidazolium cation, and quaternary ammonium cation and the anion is fluorine-containing imide-based anion.

The solute used for the non-aqueous electrolyte solution may be any known lithium salt that has been used commonly. Such a lithium salt may be a lithium salt containing at least one element among P, B, F, O, S, N, and Cl. Examples of the lithium salt include LiPF₆, LiBF₄, LiCF₃SO₃, LiN(CF₃SO₂)₂, LiN(C₂F₅SO₂)₂, LiN(CF₃SO₂)(C₄F₉SO₂), LiC(C₂F₅SO₂)₃, LiAsF₆, and LiClO₄, and mixtures thereof. In order to enhance the high-rate charge-discharge capability and the durability of the non-aqueous electrolyte secondary battery, it is particularly preferable to use LiPF₆.

(4) The separator used for the non-aqueous electrolyte secondary battery of the present invention may be made of any material as long as it is capable of preventing the short circuiting caused by the contact between the positive electrode and the negative electrode, being impregnated with a non-aqueous electrolyte solution, and obtaining lithium ion conductivity. Examples include a polypropylene separator, a polyethylene separator, and a polypropylene-polyethylene multi-layer separator.

### Advantageous Effects of Invention

The non-aqueous electrolyte secondary battery of the present invention uses a positive electrode active material in which both the niobium-containing substance and the titanium-containing substance exist on the surface of the positive electrode active material particle comprising a layered lithium-containing transition metal composite oxide containing Ni and Mn as its main components. Therefore, the valencies of the transition metals, such as nickel, in the positive electrode active material are changed, and the interface between the positive electrode and the non-aqueous electrolyte solution is modified. Thereby, the charge transfer reaction is promoted. As a result, the output power characteristics under various temperature conditions are improved. Thus, the battery can be suitably used as an electric power source for, for example, hybrid electric vehicles.

### BRIEF DESCRIPTION OF THE DRAWING

FIG. 1 is a schematic illustrative drawing of a three-electrode test cell that uses, as the working electrode, a positive electrode fabricated according to the examples of the invention and the comparative examples.

### DESCRIPTION OF EMBODIMENTS

Hereinbelow, the non-aqueous electrolyte secondary battery of the present invention will be described in further detail based on examples thereof. It should be construed, however, that the non-aqueous electrolyte secondary battery of the present invention is not limited to the following embodiments and examples, but various changes and modifications are possible without departing from the scope of the invention.

### (Preparation of Positive Electrode)

Li₂CO₃ was mixed with Ni_{10.60}Mn_{0.40}(OH)₂ obtained by coprecipitation at a predetermined ratio, and the resultant mixture was baked at 1000° C. in the air for 10 hours, to prepare a layered Li_{1.06}Ni_{0.56}Mn_{0.38}O₂ (layered lithium-containing transition metal composite oxide) containing two elements, Ni and Mn, as its main components. The Li_{1.06}Ni_{0.56}Mn_{0.38}O₂ prepared in this manner had primary particles having a volume average particle size of about 1 nm and secondary particles having a volume average particle size of about 7 μm.

Next, the just-described Li_{1.06}Ni_{0.56}Mn_{0.38}O₂ was mixed with Nb₂O₅ having an average particle size of 150 nm and TiO₂ having an average particle size of 50 nm at a predetermined ratio, and thereafter, the mixture was baked at 700° C. in the air for 1 hour, to prepare a positive electrode active material in which a niobium-containing oxide and a titanium-containing oxide were sintered on the surface of the Li_{1.06}Ni_{0.56}Mn_{0.38}O₂. The amount of niobium and the amount of titanium in the positive electrode active material prepared in this manner were determined by inductively coupled plasma spectrometry (ICP). As a result, it was found that both the amount of niobium with respect to the total amount of the transition metals in the lithium-containing transition metal composite oxide (which may hereafter referred to as simply “the niobium amount”) and the amount of titanium with respect to the total amount of the transition metals in the lithium-containing transition metal composite oxide (which may hereafter referred to as simply “the titanium amount”) were 0.5 mol %.

Next, the just-described positive electrode active material, vapor grown carbon fibers (VGCF) serving as a conductive agent, and a N-methyl-2-pyrrolidone solution in which polyvinylidene fluoride as a binder agent was dissolved, were kneaded so that the mass ratio of the positive electrode active material, the conductive agent, and the binder agent became 92:5:3, to prepare a positive electrode mixture slurry. Subsequently, the resultant positive electrode mixture slurry was applied onto a positive electrode current collector made of an aluminum foil and then dried. Thereafter, the resultant article was pressure-rolled with pressure rollers, and a positive electrode current collector tab made of aluminum was attached thereto. Thus, a positive electrode was prepared.

### (Preparation of Negative Electrode and Reference Electrode)

Metallic lithium was used for both the negative electrode (the counter electrode) and the reference electrode.

### (Preparation of Non-aqueous Electrolyte Solution)

A non-aqueous electrolyte solution was prepared by dissolving LiPF₆ at a concentration of 1.0 mol/L in a mixed solvent containing ethylene carbonate, methyl ethyl carbonate, and diethyl carbonate in a volume ratio of 3:3:4, and further dissolving 1 mass % of vinylene carbonate therein.

### (Preparation of Battery)

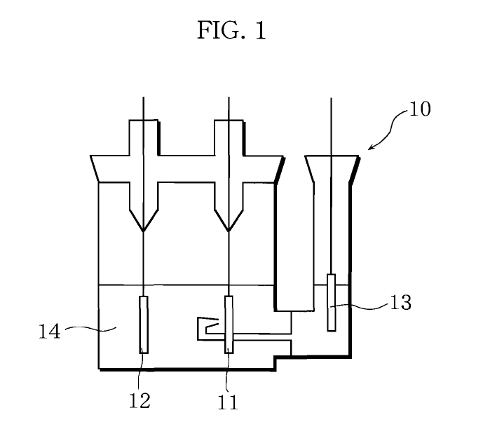

A three-electrode test cell 10 as shown in FIG. 1 was prepared using the above-described positive electrode (working electrode), the above-described negative electrode (counter electrode), the above-described reference electrode, and the above-described non-aqueous electrolyte solution. In FIG. 1, reference numeral 11 indicates the positive electrode, reference numeral 12 indicates the negative electrode, reference numeral 13 indicates the reference electrode, and reference numeral 14 indicates the non-aqueous electrolyte solution.

### EXAMPLES

### First Group of Examples

### Example 1

A cell described in the just-described embodiment was used.

The cell fabricated in this manner is hereinafter referred to as a present invention cell A1.

### Example 2

A three-electrode test cell was fabricated in the same manner as described in Example 1 above, except that the amount of Nb₂O₅ was increased in preparing the positive electrode active material. The niobium amount and the titanium amount in the positive electrode active material prepared in this manner was determined by ICP. As a result, it was found that the niobium amount and the titanium amount were 1.0 mol % and 0.5 mol %, respectively.

The cell fabricated in this manner is hereinafter referred to as a present invention cell A2.

### Example 3

A three-electrode test cell was fabricated in the same manner as described in Example 1 above, except that the amount of Nb₂O₅ and the amount of TiO₂ were decreased in preparing the positive electrode active material. The niobium amount and the titanium amount of the positive electrode active material prepared in this manner was determined by ICP. As a result, it was found that the niobium amount and the titanium amount were 0.1 mol % and 0.05 mol %, respectively.

The cell fabricated in this manner is hereinafter referred to as a present invention cell A3.

### Comparative Example 1

A three-electrode test cell was fabricated in the same manner as described in Example 1 above, except that Nb₂O₅ and TiO₂ were not added (i.e., the lithium-containing transition metal composite oxide composed of Li_{1.06}Ni_{0.56}Mn_{0.38}O₂ alone was used as the positive electrode active material).

The cell fabricated in this manner is hereinafter referred to as a comparative cell Z1.

### Comparative Example 2

A three-electrode test cell was fabricated in the same manner as described in Example 1 above, except that the amount of TiO₂ was increased in preparing the positive electrode active material. The niobium amount and the titanium amount of the positive electrode active material prepared in this manner was determined by ICP. As a result, it was found that the niobium amount and the titanium amount were 0.5 mol % and 1.0 mol %, respectively.

The cell fabricated in this manner is hereinafter referred to as a comparative cell Z2.

### Comparative Example 3

A three-electrode test cell was fabricated in the same manner as described in Example 1 above, except that the amount of Nb₂O₅ and the amount of TiO₂ were increased in preparing the positive electrode active material. The niobium amount and the titanium amount of the positive electrode active material prepared in this manner was determined by ICP. As a result, it was found that both the niobium amount and the titanium amount were 1.0 mol %.

The cell fabricated in this manner is hereinafter referred to as a comparative cell Z3.

### Comparative Example 4

A three-electrode test cell was fabricated in the same manner as described in Example 1 above, except that the amount of Nb₂O₅ and the amount of TiO₂ were decreased in preparing the positive electrode active material. The niobium amount and the titanium amount of the positive electrode active material prepared in this manner was determined by ICP. As a result, it was found that both the niobium amount and the titanium amount were 0.05 mol %.

The cell fabricated in this manner is hereinafter referred to as a comparative cell Z4.

### (Experiment)

Each of the present invention cells A1 through A3 and the comparative cells Z1 through Z4 was charged and discharged under the following conditions to determine the output power characteristic of each of the cells. The results are shown in Table 1. It should be noted that in Table 1, the output power characteristics are shown as index numbers relative to the output power of the comparative cell Z1, which is taken as 100.

Charge-Discharge Conditions

First, under the temperature condition at 25° C., the present invention cells A1 through A3 and the comparative cells Z1 through Z4 were charged at a constant current density of 0.2 mA/cm² to 4.3 V (vs. Li/Li⁺), then further charged at a constant voltage of 4.3 V (vs. Li/Li⁺) until the current density reached 0.04 mA/cm², and thereafter discharged at a constant current density of 0.2 mA/cm² to 2.5 V (vs. Li/Li⁺). The discharge capacity obtained at this time was determined as the rated capacity of each of the present invention cells A1 through A3 and the comparative cells Z1 through Z4.

Next, under the temperature condition of 25° C., each of the present invention cells A1 through A3 and the comparative cells Z1 through Z4 was charged at the same current density as described above to 50% of the rated capacity, and then discharged at the same current density as described above. Thereby, the output power at the point at which the state of charge (SOC) was 50% was determined.

TABLE 1

| | Positive electrode active material | | | | |
|---|---|---|---|---|---|
| | Lithium-containing | | | | Output power |
| | transition metal | Niobium | Titanium | Total | characteristic |
| Cell | composite oxide | amount | amount | amount | at 25° C. |
| Invention cell | Li_{1.06}Ni_{0.56}Mn_{0.38}O₂ | 0.5 mol % | 0.5 mol % | 1.0 mol % | 123 |
| A1 | | | | | |
| Invention cell | | 1.0 mol % | 0.5 mol % | 1.5 mol % | 116 |
| A2 | | | | | |
| Invention cell | | 0.1 mol % | 0.05 mol % | 0.15 mol % | 107 |
| A3 | | | | | |
| Comparative cell | | — | — | — | 100 |
| Z1 | | | | | |
| Comparative cell | | 0.5 mol % | 1.0 mol % | 1.5 mol % | 99 |
| Z2 | | | | | |
| Comparative cell | | 1.0 mol % | 1.0 mol % | 2.0 mol % | 76 |
| Z3 | | | | | |
| Comparative cell | | 0.05 mol % | 0.05 mol % | 0.1 mol % | 97 |
| Z4 | | | | | |

As clearly seen from Table 1 above, it is observed that the output power characteristic is remarkably higher in the present invention cells A1 through A3, which use the positive electrode active material represented as Li_{0.06}Ni_{0.56}Mn_{0.38}O₂ containing niobium and titanium existing on the surface of the lithium-containing transition metal composite oxide, in which the total amount of the niobium and the titanium is from 0.15 mol % to 1.5 mol %, and in which the amount of the niobium is equal to or greater than that of the titanium, than in the comparative cell Z1, in which niobium or titanium does not exist on the surface of the lithium-containing transition metal composite oxide.

In contrast, it is observed that the comparative cell Z4, in which niobium and titanium exist on the surface of the lithium-containing transition metal composite oxide but the total amount of the niobium and the titanium is 0.10 mol %, does not exhibit the advantageous effects with the present invention cells A1 through A3 and shows a lower output power characteristic, because the amounts of niobium and titanium added are too small. Also, it is observed that the comparative cell Z3, in which niobium and titanium exist on the surface of the lithium-containing transition metal composite oxide but the total amount of the niobium and the titanium is 2.0 mol %, likewise shows a lower output power characteristic. The reason is that the amounts of niobium and titanium added are too large and thereby the niobium and the titanium cannot be dispersed uniformly.

In addition, it is observed that the comparative cell Z2, in which niobium and titanium exist on the surface of the lithium-containing transition metal composite oxide and the total amount of the niobium and the titanium is within the range of from 0.15 mol % to 1.5 mol % but the amount of the niobium is not equal to or greater than that of titanium (the amount of titanium is greater than that of niobium), shows a lower output power characteristic. This indicates that, even in the case of using the positive electrode active material in which a group 4A element and a group 5A element are added to a lithium-containing transition metal composite oxide, as in the case of the aforementioned Patent Document 4, the output power characteristic cannot be improved if the amounts of the elements added are not controlled.

These results of the experiment demonstrate that the positive electrode active material needs to be a positive electrode active material in which niobium and titanium exist on the surface of the lithium-containing transition metal composite oxide, that the total amount of the niobium and the titanium needs to be from 0.15 mol % to 1.5 mol % with respect to the total amount of the transition metals in the lithium-containing transition metal composite oxide, and that the amount of the niobium needs to be equal to or greater than that of the titanium.

### Second Group of Examples

### Example

A three-electrode test cell was prepared in the same manner as described in Example 1 of the first group of examples above, except that layered Li_{1.07}Ni_{0.46}Co_{0.19}Mn_{0.28}O₂ was used as the lithium-containing transition metal composite oxide.

The just-mentioned lithium-containing transition metal composite oxide was prepared in the following manner. Li₂CO₃ and a coprecipitated hydroxide represented as Ni_{0.5}Co_{0.2}Mn_{0.3}(OH)₂ were mixed together at a predetermined ratio, and the resulting mixture was baked in the air at 850° C. for 10 hours. The Li_{1.07}Ni_{0.46}Co_{0.19}Mn_{0.28}O₂ prepared in this manner had primary particles having a volume average particle size of about 1 μm and secondary particles having a volume average particle size of about 6 μm.

The cell fabricated in this manner is hereinafter referred to as a present invention cell B.

### Comparative Example 1

A three-electrode test cell was fabricated in the same manner as described in Example above, except that Nb₂O₅ and TiO₂ were not added (i.e., the lithium-containing transition metal composite oxide composed of Li_{1.07}Ni_{0.46}Co_{0.19}Mn_{0.28}O₂ alone was used as the positive electrode active material).

The cell fabricated in this manner is hereinafter referred to as a comparative cell Y1.

### Comparative Example 2

A three-electrode test cell was fabricated in the same manner as described in Example above, except that in preparing the positive electrode active material, Nb₂O₅ alone was added and thereafter the baking was performed to prepare the positive electrode active material. The niobium amount of the positive electrode active material prepared in this manner was determined by ICP. As a result, it was found that the niobium amount was 1.0 mol %.

The cell fabricated in this manner is hereinafter referred to as a comparative cell Y2.

### (Experiment)

Each of the present invention cell B and the comparative cells Y1 and Y2 was charged and discharged under the same conditions as described in Experiment of the first group of examples to determine the output power characteristic of each of the cells. (Note that, as for the temperature, the experiment was also conducted at −30° C. in addition to 25° C.) The results are shown in Table 2. It should be noted that in Table 2, the output power characteristics are shown as index numbers relative to the output power of the comparative cell Y1, which is taken as 100.

TABLE 2

| | Positive electrode active material | | | | | |
|---|---|---|---|---|---|---|
| | Lithium-containing | | | | Output power | Output power |
| | transition metal | Niobium | Titanium | Total | characteristic | characteristic |
| Cell | composite oxide | amount | amount | amount | at 25° C. | at −30° C. |
| Invention | Li_{1.07}Ni_{0.46}CO_{0.19}Mn_{0.28}O₂ | 0.5 mol % | 0.5 mol % | 1.0 mol % | 110 | 143 |
| cell B | | | | | | |
| Comparative | | — | — | — | 100 | 100 |
| cell Y1 | | | | | | |
| Comparative | | 1.0 mol % | — | 1.0 mol % | 106 | 125 |
| cell Y2 | | | | | | |

As clearly seen from Table 2 above, it is observed that the output power characteristic is remarkably higher both at 25° C. and at −30° C. in the present invention cell B, which uses the positive electrode active material containing 0.5 mol % of niobium and 0.5 mol % of titanium existing on the surface of the lithium-containing transition metal composite oxide represented as Li_{1.07}Ni_{0.46}Co_{0.19}Mn_{0.28}O₂, than in the comparative cell Y1, in which no niobium or titanium exists on the surface of the lithium-containing transition metal composite oxide.

It is observed that the output power characteristic is higher both at 25° C. and at −30° C. in the comparative cell Y2, in which niobium alone exists on the surface of the lithium-containing transition metal composite oxide (the total amount of the niobium added is 1.0 mol %, so the total amount of the added substances is the same as that in the present invention cell B), than in the comparative cell Y1. However, but the degree of the improvement is considerably lower than that obtained by the present invention cell B. This indicates that both niobium and titanium need to exist on the surface of the lithium-containing transition metal composite oxide.

It is also observed that the degree of improvement in the output power (25° C.) of the foregoing present invention cell A1 over the foregoing comparative cell Z1 is greater than the degree of improvement in the output power (25° C.) of the present invention cell B over the comparative cell Y1. The reason is believed to be as follows. The resistance at the interface between the positive electrode and the non-aqueous electrolyte solution is higher in the positive electrode active material containing Co in an amount of less than 10%, as in the present invention cell A1, than in the positive electrode active material containing a greater amount of Co than that (the positive electrode active material of the present invention cell B). For this reason, the effect of modifying the interface between the positive electrode and the non-aqueous electrolyte solution, which results from both the niobium-containing substance and the titanium-containing substance existing on the surface of the positive electrode active material particle, is greater. So, the charge transfer reaction is promoted remarkably.

### Third Group of Examples

### Example

A three-electrode test cell was prepared in the same manner as described in Example 1 of the first group of examples above, except that layered Li_{1.09}Ni_{0.36}Co_{0.19}Mn_{0.36}O₂ was used as the lithium-containing transition metal composite oxide.

The just-mentioned lithium-containing transition metal composite oxide was prepared in the following manner. Li₂CO₃ and a coprecipitated hydroxide represented as Ni_{0.4}Co_{0.2}Mn_{0.4}(OH)₂ were mixed together at a predetermined ratio, and the resulting mixture was baked in the air at 900° C. for 10 hours. The Li_{1.09}Ni_{0.36}Co_{0.19}Mn_{0.36}O₂ prepared in this manner had primary particles having a volume average particle size of about 1 nm and secondary particles having a volume average particle size of about 6 μm.

The cell fabricated in this manner is hereinafter referred to as a present invention cell C.

### Comparative Example 1

A three-electrode test cell was fabricated in the same manner as described in Example above, except that Nb₂O₅ and TiO₂ were not added (i.e., the lithium-containing transition metal composite oxide composed of Li_{1.09}Ni_{0.36}Co_{0.19}Mn_{0.36}O₂ alone was used as the positive electrode active material).

The cell fabricated in this manner is hereinafter referred to as a comparative cell X1.

### Comparative Example 2

A three-electrode test cell was fabricated in the same manner as described in Example above, except that in preparing the positive electrode active material, Nb₂O₅ alone was added and thereafter the baking was performed to prepare the positive electrode active material. The niobium amount of the positive electrode active material prepared in this manner was determined by ICP. As a result, it was found that the niobium amount was 1.0 mol %.

The cell fabricated in this manner is hereinafter referred to as a comparative cell X2.

### (Experiment)

Each of the present invention cell C and the comparative cells X1 and X2 was charged and discharged under the same conditions as described in Experiment of the First Group of Examples to determine the output power characteristic of each of the cells.

(Note that, as for the temperature, the experiment was also conducted at −30° C.) The results are shown in Table 3. It should be noted that in Table 3, the output power characteristics are shown as index numbers relative to the output power of the comparative cell X1, which is taken as 100.

TABLE 3

| | Positive electrode active material | | | | |
|---|---|---|---|---|---|
| | Lithium-containing | | | | Output power |
| | transition metal | Niobium | Titanium | Total | characteristic |
| Cell | composite oxide | amount | amount | amount | at −30° C. |
| Invention cell C | Li_{1.09}Ni_{0.36}Co_{0.19}Mn_{0.36}O₂ | 0.5 mol % | 0.5 mol % | 1.0 mol % | 148 |
| Comparative cell | | — | — | — | 100 |
| X1 | | | | | |
| Comparative cell | | 1.0 mol % | — | 1.0 mol % | 129 |
| X2 | | | | | |

As clearly seen from Table 3, it is observed that the output power characteristic at −30° C. is higher in the present invention cell C, which uses the positive electrode active material containing 0.5 mol % of niobium and 0.5 mol % of titanium existing on the surface of the lithium-containing transition metal composite oxide represented as Li_{1.09}Ni_{0.36}Co_{0.19}Mn_{0.36}O₂, than in the comparative cell X1, in which no niobium or titanium exists on the surface of the lithium-containing transition metal composite oxide.

It is also observed that the output power characteristic at −30° C. is higher in the comparative cell X2, in which niobium alone exists on the surface of the lithium-containing transition metal composite oxide (the total amount of the niobium added is 1.0 mol %, so the total amount of the added substances is the same as that in the present invention cell C), than in the comparative cell X1. However, the degree of the improvement is considerably lower than that obtained by the present invention cell C. This indicates that both niobium and titanium need to exist on the surface of the lithium-containing transition metal composite oxide.

### Fourth Group of Examples

### Comparative Example 1

A three-electrode test cell was prepared in the same manner as described in Example 1 of the first group of examples above, except that layered Li_{1.02}Ni_{0.78}Co_{0.19}Al_{0.03}O₂ was used as the lithium-containing transition metal composite oxide.

The just-mentioned lithium-containing transition metal composite oxide was prepared in the following manner. Li₂CO₃ and a coprecipitated hydroxide represented as Ni_{0.78}Co_{0.19}Al_{0.03}(OH)₂ were mixed together so that the mole ratio of the total of the lithium and the transition metals became 1.02:1, and the resulting mixture was heat-treated in the air at 750° C. for 20 hours. The Li_{1.02}Ni_{0.78}Co_{0.19}Al_{0.03}O₂ prepared in this manner had primary particles having a volume average particle size of about 1 μm and secondary particles having a volume average particle size of about 12.5 μm. The niobium amount and the titanium amount of the just-described positive electrode active material was determined by ICP. As a result, it was found that the niobium amount and the titanium amount were 0.5 mol % and 0.5 mol %, respectively.

The cell fabricated in this manner is hereinafter referred to as a comparative cell W1.

### Comparative Example 2

A three-electrode test cell was fabricated in the same manner as described in Comparative Example 1 above, except that Nb₂O₅ and TiO₂ were not added (i.e., the lithium-containing transition metal composite oxide composed of Li_{1.02}Ni_{0.78}Co_{0.19}Al_{0.03}O₂ alone was used as the positive electrode active material).

The cell fabricated in this manner is hereinafter referred to as a comparative cell W2.

### (Experiment)

Each of the comparative cells W1 and W2 was charged and discharged under the following conditions to determine the output power characteristic of each of the cells. The results are shown in Table 4. It should be noted that in Table 4, the output power characteristics are shown as index numbers relative to the output power of the comparative cell W2, which is taken as 100.

TABLE 4

| | Positive electrode active material | | | | |
|---|---|---|---|---|---|
| | Lithium-containing | | | | Output power |
| | transition metal | Niobium | Titanium | Total | characteristic |
| Cell | composite oxide | amount | amount | amount | at 25° C. |
| Comparative cell | Li_{1.02}Ni_{0.78}Co_{0.19}Al_{0.03}O₂ | 0.5 mol % | 0.5 mol % | 1.0 mol % | 98 |
| W1 | | | | | |
| Comparative cell | | — | — | — | 100 |
| W2 | | | | | |

As clearly seen from Table 4, it is observed that the output power characteristic is not improved in the comparative cell W1, which uses the positive electrode active material containing 0.5 mol % of niobium and 0.5 mol % of titanium existing on the surface of the lithium-containing transition metal composite oxide comprising Li_{1.02}Ni_{0.78}Co_{0.19}Al_{0.03}O₂ over the comparative cell W1, in which no niobium or titanium exists on the surface of the lithium-containing transition metal composite oxide comprising Li_{1.02}Ni_{0.78}Co_{0.19}Al_{0.03}O₂.

This demonstrates that the output power characteristic cannot be improved if the lithium-containing transition metal composite oxide containing Ni and Mn as its main components is not used as the lithium-containing transition metal composite oxide (if Li_{1.02}Ni_{0.78}Co_{0.19}Al_{0.03}O₂ is used as the lithium-containing transition metal composite oxide as in the comparative cell W1), even in the case where the niobium-containing substance and the titanium-containing substance exist on the surface of the lithium-containing transition metal composite oxide, the total amount of niobium and titanium is from 0.15 mol % to 1.5 mol % with respect to the total amount of the transition metals in the lithium-containing transition metal composite oxide, and moreover the niobium amount is equal to or greater than the titanium amount. Therefore, it will be understood that the improvement effect of the output power characteristic is an effect obtained uniquely when using the lithium-containing transition metal composite oxide containing Ni and Mn as its main components.

It is also clear from the previously-mentioned Patent Document 3 that, when using the positive electrode active material obtained by allowing niobium oxide or titanium oxide to exist on the surface of a lithium-nickel composite oxide (LiNi_{0.82}Co_{0.15}Al_{0.03}O₂) and baking the lithium-nickel composite oxide, the high-rate discharge capability and the low-temperature discharge capability are rather lowered, although the thermal stability of the positive electrode is improved.

### INDUSTRIAL APPLICABILITY

The non-aqueous electrolyte secondary battery containing the positive electrode according to the present invention may be used as a power source for various applications, such as a power source for hybrid electric vehicles.

### LIST OF REFERENCE NUMERALS

10-Three-electrode test cell
11-Working electrode (positive electrode)
12-Counter electrode (negative electrode)
13-Reference electrode
14-Non-aqueous electrolyte solution

1. A non-aqueous electrolyte secondary battery comprising: a positive electrode containing a positive electrode active material; a negative electrode containing a negative electrode active material; and a non-aqueous electrolyte solution containing a solute dissolved in a non-aqueous solvent, the non-aqueous electrolyte secondary battery being characterized in that: the positive electrode active material comprises a layered lithium-containing transition metal composite oxide containing Ni and Mn as its main components, and a niobium-containing substance and a titanium-containing substance existing on a surface of the lithium-containing transition metal composite oxide; the total amount of niobium in the niobium-containing substance and titanium in the titanium-containing substance is from 0.15 mol % to 1.5 mol % with respect to the total amount of transition metals in the lithium-containing transition metal composite oxide; and the number of moles of the niobium in the niobium-containing substance is equal to or greater than the number of moles of the titanium in the titanium-containing substance.

2. The non-aqueous electrolyte secondary battery according to claim 1, wherein the lithium-containing transition metal composite oxide is represented by the general formula Li₁₊ₓNiₐMn_{b}CO_{c}O_{2+d}, where x, a, b, c, and d satisfy the following expressions: x+a+b+c=1, 0<x≦0.1, 0≦c/(a+b)<0.40, 0.7≦a/b≦3.0, and −0.1≦d≦0.1.

3. The non-aqueous electrolyte secondary battery according to claim 2, wherein 0≦c/(a+b)<0.35 and 0.7≦a/b≦2.0 in the general formula Li₁₊ₓNiₐMn_{b}CO_{c}O_{2+d}.

4. The non-aqueous electrolyte secondary battery according to claim 3, wherein 0≦c/(a+b)<0.15 and 0.7≦a/b≦1.5 in the general formula Li₁₊ₓNiₐMn_{b}CO_{c}O_{2+d}.

5. The non-aqueous electrolyte secondary battery according to claim 1, wherein the niobium-containing substance and the titanium-containing substance are sintered on the surface of the lithium-containing transition metal composite oxide.

6. The non-aqueous electrolyte secondary battery according to claim 2, wherein the positive electrode active material comprises primary particles having a volume average particle size of from 0.5 μm to 2 μm and secondary particles having a volume average particle size of from 4 μm to 15 μm.

7. The non-aqueous electrolyte secondary battery according to claim 3, wherein the non-aqueous solvent of the non-aqueous electrolyte solution comprises a mixed solvent containing a cyclic carbonate and a chain carbonate in a volume ratio of from 2:8 to 5:5.

8. The non-aqueous electrolyte secondary battery according to claim 4, wherein the niobium-containing substance and the titanium-containing substance are sintered on the surface of the lithium-containing transition metal composite oxide.

9. The non-aqueous electrolyte secondary battery according to claim 1, wherein the positive electrode active material comprises primary particles having a volume average particle size of from 0.5 μm to 2 μm and secondary particles having a volume average particle size of from 4 μm to 15 μm.

10. The non-aqueous electrolyte secondary battery according to claim 2, wherein the positive electrode active material comprises primary particles having a volume average particle size of from 0.5 μm to 2 μm and secondary particles having a volume average particle size of from 4 μm to 15 μm.

11. The non-aqueous electrolyte secondary battery according to claim 3, wherein the positive electrode active material comprises primary particles having a volume average particle size of from 0.5 μm to 2 μm and secondary particles having a volume average particle size of from 4 μm to 15 μm.

12. The non-aqueous electrolyte secondary battery according to claim 4, wherein the positive electrode active material comprises primary particles having a volume average particle size of from 0.5 μm to 2 μm and secondary particles having a volume average particle size of from 4 μm to 15 μm.

13. The non-aqueous electrolyte secondary battery according to claim 5, wherein the positive electrode active material comprises primary particles having a volume average particle size of from 0.5 μm to 2 μm and secondary particles having a volume average particle size of from 4 μm to 15 μm.

14. The non-aqueous electrolyte secondary battery according to claim 1, wherein the non-aqueous solvent of the non-aqueous electrolyte solution comprises a mixed solvent containing a cyclic carbonate and a chain carbonate in a volume ratio of from 2:8 to 5:5.

15. The non-aqueous electrolyte secondary battery according to claim 2, wherein the non-aqueous solvent of the non-aqueous electrolyte solution comprises a mixed solvent containing a cyclic carbonate and a chain carbonate in a volume ratio of from 2:8 to 5:5.

16. The non-aqueous electrolyte secondary battery according to claim 3, wherein the non-aqueous solvent of the non-aqueous electrolyte solution comprises a mixed solvent containing a cyclic carbonate and a chain carbonate in a volume ratio of from 2:8 to 5:5.

17. The non-aqueous electrolyte secondary battery according to claim 4, wherein the non-aqueous solvent of the non-aqueous electrolyte solution comprises a mixed solvent containing a cyclic carbonate and a chain carbonate in a volume ratio of from 2:8 to 5:5.

18. The non-aqueous electrolyte secondary battery according to claim 5, wherein the non-aqueous solvent of the non-aqueous electrolyte solution comprises a mixed solvent containing a cyclic carbonate and a chain carbonate in a volume ratio of from 2:8 to 5:5.

19. The non-aqueous electrolyte secondary battery according to claim 9, wherein the non-aqueous solvent of the non-aqueous electrolyte solution comprises a mixed solvent containing a cyclic carbonate and a chain carbonate in a volume ratio of from 2:8 to 5:5.
